(19) United States
(12) Patent Application Publication
(10) Pub. No.: US 2026/0098421 A1
(43) Pub. Date: Apr. 9, 2026

(54) BuzzCaps

(71) Applicants: John Pierson, Kennebunk, ME (US); Lisa Pierson, Kennebunk, ME (US)

(72) Inventors: John Pierson, Kennebunk, ME (US); Lisa Pierson, Kennebunk, ME (US)

(21) Appl. No.: 18/907,819

(22) Filed: Oct. 7, 2024

(51) Int. Cl. E04H 17/00; F21V 21/116; F21V 37/00

(52) U.S. Cl. CPC E04H 17/006; F21V 21/116; F21V 37/0004

(57) ABSTRACT

A device that attaches to fence posts, deck posts or pole including an oil torch, wick, snuffer and base cap that allows for safe, easy and secure installation of oil torches on existing or new fences, decks, docks, patios or free-standing posts. The device will add aesthetic value while enabling otherwise dormant structures to distribute mosquito deterrent oils such as citronella.

This application claims the benefit of U.S. Provisional Ser. No. 63/590,712 , filed Oct. 16, 2023, the contents of which are incorporated herein by reference.

### FIELD

The present invention relates generally to building construction products and more specifically to caps for fence post that function as a holder for oil torches and other decorative items.

### BACKGROUND OF THE INVENTION

Oil torches are very popular in outdoor environments but there are limited options for deploying them effectively. Existing methods of oil torch deployment are unstable, unsightly and are not appropriate for all environments. In addition, a growing number of homes in the United States have deck and fence posts surrounding outdoor environments.

There is a substantial need for a secure, attractive and effective way to deploy oil torches around and in outdoor living spaces utilizing features that many properties already have.

Oil torches are popular for outdoor lighting and ambiance, and to provide a method to burn citronella oils for mosquito deterrence. While various designs for torch holders exist, none offer a convenient way to integrate them into existing fencing structures seamlessly as a fence cap.

### SUMMARY OF THE INVENTION

Briefly described, the product provides a fence cap designed to fit on the top of fence or deck posts. The innovative fence cap incorporates a designated holder for a torch, allowing for easy installation and stability. The unique design not only secures the torch, but also fits on a variety of sized fence posts due to the unique internal design characteristics (FIG. 1).

Generally, the present device is a PVC form with a circular recess to accommodate an oil torch canister or other similarly shaped aesthetic component. In a preferred form, the cap fits in or around most fence or deck posts with no additional tools or fasteners.

A secondary use for the device is a secure and standalone torch holder to be used on tables and other flat surfaces.

A further object is to provide a metallic cap for metal fence posts in a variety of shapes and designs with the same basic premise of securely holding an oil torch canister.

### BRIEF DESCRIPTION OF THE DRAWING FIGURES

FIG. 1 is a profile drawing of the Torch Holding Fence Cap with torch canister insert for clarity of form, fit and function

FIG. 2 is a perspective rendering of the Torch Holding Fence Cap of FIG. 1, where the cap is shown from the bottom to demonstrate universal fit design features.

FIG. 3 is a photographic view of the Torch Holding Fence Cap of FIG. 1, where the cap is shown secured on a market available 4″ post adapter utilizing the interior design features highlighted in FIG. 2.

FIG. 4 is a photographic view of the Torch Holding Fence Cap of FIG. 1, where the cap is shown secured on a market available 5″ post with no required adapter utilizing the interior design features highlighted in FIG. 2.

FIG. 5 is perspective rendering of the metallic base cap for the Torch Holding Fence Cap.

### DETAILED DESCRIPTION

In describing the preferred and alternate embodiments of the present invention, specific terminology is employed for the sake of clarity. The invention, however, is not intended to be limited to the specific terminology so selected.

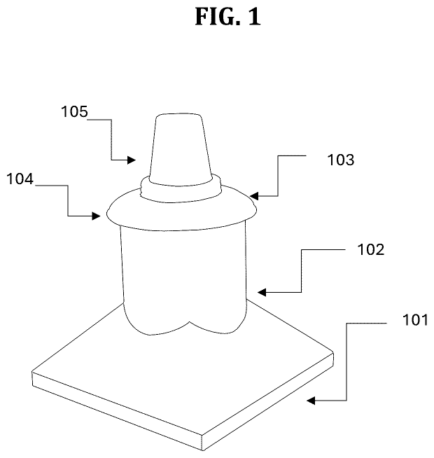

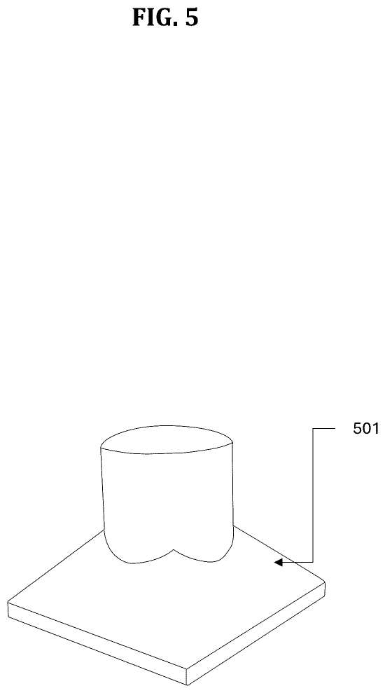

Referring now in detail to the drawing figures, wherein like reference numerals represent like parts throughout the several views, FIGS. 1-5 show a torch holding fence cap according to a preferred form of the invention. The cap preferably comprises a PVC or metallic base cap 501 and an oil torch canister 103, 104, 105.

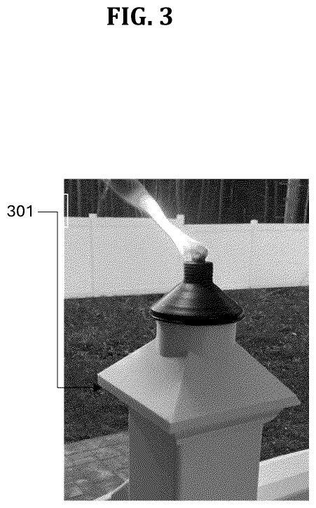

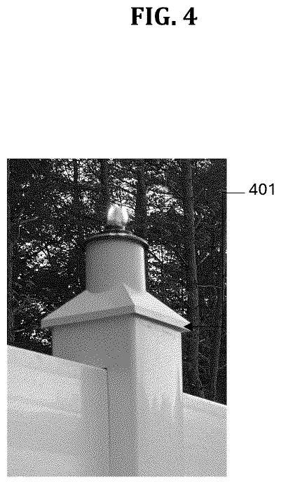

In the preferred form, the torch holding fence cap FIG. 1-5 is a two-piece modular base cap coupled with a metallic oil canister 103 with heat shield 104 and wick snuffer 105, wherein the base cap 101 is molded plastic or formed metal surrounding designed to attach firmly to an existing post FIG. 3-4. However, one skilled in the art will recognize that alternative materials may be used such as, for exemplary purposes only, rubber or glass fiber. Preferably, the cap 501 is formed by a peripheral wall 203 defining an interior cavity 204 which allows for oil canister 104 to reside without interference from internal support posts within the desired mounting post. The peripheral wall 203 generally has a top exterior wall of sufficient density and thickness to provide strength and durability yet remain lightweight and flexible. Although the thickness of the peripheral wall 203 may vary, the preferred thickness is 0.2 mm to 0.3 mm.

The circular protrusion 102 is designed to elevate the oil torch from the fence post and surround fence materials and accommodates oil torch canister 103.

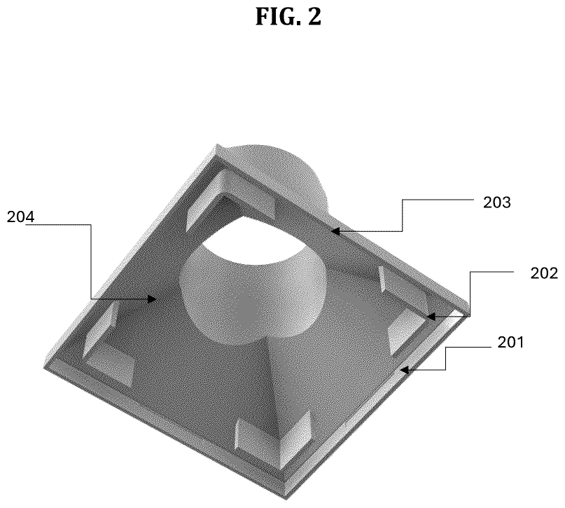

The interior design FIG. 2 allows for multiple connections to posts and post adapters through protruding interior posts, poles or geometric shapes 202 which will fit inside or surround existing posts or post cavities which is exemplified in FIG. 3-4. The small channel insert 201 allows the cap to connect to market available 4″ pvc caps and adapters to accommodate smaller post sizes as demonstrated in FIG. 301.

The small lip 101 allows the cap to overlap existing posts or post adapters to keep water out of the interior of post cavities.

The cap sits on top of 5″ posts by inserting interior channel, or by setting exterior lip around exterior of post 501.

What is claimed is:

1-3. (canceled)

4. A fence cap that is capable of securely holding an oil canister torch and attaching to a fence or deck post of various material types and sizes.

5. The fence cap of claim 4, wherein the fence cap enables torches to be elevated above fences and fence posts thereby reducing the risk of damage or fire, wherein the fence cap includes an aluminum heat shield, further wherein the fence cap comprises a removable base cap that allows for removal and replacement of an oil canister to allow for filling and replacement of oil.

6. The fence cap of claim 4, wherein the fence cap will attach in a variety of manners to a variety of size posts because of the multiple attachment methodologies referenced herein.

7. The fence cap of claim 4, wherein the fence cap sits on top of, inserts inside of, or connects through mechanical fashion to existing posts, poles and post accessories.

8. A fence cap for a fence post comprising: a body designed to fit on the top of the fence post, a torch holder integrally formed with the body, wherein the holder is configured to retain a torch securely.

9. The fence cap of claim 8, further including drainage holes within the torch holder to prevent water accumulation.

10. The fence cap of claim 8, wherein the body is made from weather-resistant materials.

11. The fence cap of claim 8, wherein the holder may include a locking mechanism to secure the torch in place.

12. The fence cap of claim 8. featuring decorative elements to enhance the aesthetic appeal of the fence.

13. The Fence cap of claim 8, may hold other accessories securely in the same fashion that it holds a torch
